(19) United States
(12) Patent Application Publication
(10) Pub. No.: US 2018/0213385 A1
(43) Pub. Date: Jul. 26, 2018

(54) WIRELESS TERMINAL APPARATUS, NETWORK NODE, AND METHOD

(71) Applicant: NEC Corporation, Tokyo (JP)

(72) Inventors: Hiroaki AMINAKA, Tokyo (JP); Kazushi MURAOKA, Tokyo (JP)

(73) Assignee: NEC Corporation, Tokyo (KR)

(21) Appl. No.: 15/578,396

(22) PCT Filed: Jan. 21, 2016
(86) PCT No.: PCT/JP2016/000292

§ 371 Date: Nov. 30, 2017

(30) Foreign Application Priority Data
Jun. 2, 2015 (JP) 2015-112699

(51) Int. Cl. H04W 8/00; H04W 56/00

(52) U.S. Cl. CPC H04W 8/005; H04W 92/18; H04W 56/001

(57) ABSTRACT

A wireless terminal (1A) receives a discovery signal (201) wirelessly transmitted from another wireless terminal (1B) via device-to-device (D2D) communication, and transmits a discovery report (202, 302) to a network (2, 3) via cellular communication (101). The discovery report indicates at least one of: (a) an identifier of the other wireless terminal (1B); (b) an identifier(s) of one or more D2D communication pairs to which the other wireless terminal (1B) belongs; (c) an identifier of a base station or a cell with which the other wireless terminal (1B) is associated; (d) received power of a discovery signal from the other wireless terminal (1B); and (e) the number of detections of the discovery signal from the other wireless terminal (1B). It is thus possible to provide a discovery report containing contents suitable for use in a network.

### TECHNICAL FIELD

The present disclosure relates to inter-terminal direct communication (device-to-device (D2D) communication) and, in particular, to discovery for neighboring wireless terminals in D2D communication.

### BACKGROUND ART

In some implementations, a wireless terminal is configured to communicate directly with another wireless terminal (see, for example, Patent Literature 1). Such communication is called device-to-device (D2D) communication. The D2D communication includes at least one of direct communication and direct discovery. In some implementations, a plurality of wireless terminals supporting the D2D communication form a D2D communication group autonomously, or under the control of a network, to communicate with another wireless terminal within the D2D communication group.

3GPP Release 12 defines Proximity-based services (ProSe) (see, for example, Non-Patent Literature 1). ProSe includes ProSe discovery and ProSe direct communication. ProSe discovery makes it possible to detect that wireless terminals are in proximity to each other. ProSe discovery includes direct discovery (i.e., ProSe direct discovery) and network-level discovery (i.e., EPC-level ProSe discovery).

ProSe direct discovery is performed through a procedure in which a wireless terminal capable of performing ProSe (i.e., ProSe-enabled User Equipment (UE)) discovers another ProSe-enabled UE by using only the capability of a radio communication technology (e.g., Evolved Universal Terrestrial Radio Access (E-UTRA) technology) possessed by these two UEs. On the other hand, in EPC-level ProSe discovery, a core network (i.e., Evolved Packet Core (EPC)) determines proximity of two ProSe-enabled UEs and informs these UEs of the detection of proximity. ProSe direct discovery may be performed by three or more ProSe-enabled UEs.

ProSe direct communication enables establishment of a communication path(s) between two or more ProSe-enabled UEs existing in a direct communication range after the ProSe discovery procedure is performed. In other words, ProSe direct communication enables a ProSe-enabled UE to directly communicate with another ProSe-enabled UE without traversing a public land mobile network (PLMN) including a base station (eNodeB). ProSe direct communication may be performed by using a radio communication technology that is also used to access a base station (eNodeB) (i.e., E-UTRA technology) or by using a wireless local area network (WLAN) radio technology (i.e., IEEE 802.11 radio technology).

ProSe direct discovery and ProSe direct communication are performed on a direct interface between UEs. This direct interface is referred to as a PC5 interface or a sidelink. That is, ProSe direct discovery and ProSe direct communication are examples of the D2D communication. The D2D communication can also be referred to as sidelink communication or may be referred to as peer-to-peer communication.

In 3GPP Release 12, a ProSe function communicates with a ProSe-enabled UE via a public land mobile network (PLMN) and assists ProSe Discovery and ProSe direct communication. The ProSe Function is a logical function that is used for PLMN-related operations required for ProSe. The functionality provided by the ProSe function includes, for example: (a) communication with third-party applications (ProSe Application Server), (b) authentication of a UE for ProSe Discovery and ProSe direct communication, (c) transmission of configuration information for ProSe Discovery and ProSe direct communication (e.g., EPC-ProSe-User ID), and (d) providing of network-level discovery (i.e., EPC-level ProSe discovery). The ProSe function may be implemented in one or more network nodes or entities. In this specification, one or more network nodes or entities that implement the ProSe function are referred to as a “ProSe function entity” or a “ProSe function server”.

Note that 3GPP Release 12 ProSe is one example of Proximity-based services (ProSe) that are provided based on geographic proximity of a plurality of wireless terminals. Similarly to 3GPP Release 12 ProSe, the proximity-based services in a Public Land Mobile Network (PLMN) include discovery phase and direct communication phases assisted by a function or a node (e.g., ProSe function) located in the network. In the discovery phase, geographic proximity of wireless terminals is determined or detected. In the direct communication phase, wireless terminals perform direct communication. The direct communication is performed between wireless terminals in proximity to each other without traversing a public land mobile network (PLMN).

### CITATION LIST

### Non Patent Literature

Non-Patent Literature 1: 3GPP TS 23.303 V12.4.0 (2015 March ), “3rd Generation Partnership Project; Technical Specification Group Services and System Aspects; Proximity-based services (ProSe); Stage 2 (Release 12)”, March 2015

### Patent Literature

Patent Literature 1: Japanese Unexamined Patent Application Publication No. 2013-223192

### SUMMARY OF INVENTION

### Technical Problem

As described above, 3GPP Release 12 ProSe provides direct discovery (i.e., ProSe direct discovery) and network-level discovery (i.e., EPC-level ProSe discovery) for detecting proximity of two or more UEs.

EPC-level ProSe discovery uses location information of two or more UEs to determine the proximity of these UEs. The location information of a UE is, for example, Global Navigation Satellite System (GNSS) location information obtained by a GNSS receiver. However, the determination of the proximity by EPC-level ProSe discovery alone may not be sufficient to determine whether two or more UEs can actually communicate with each other. For example, even if two UEs are geographically close to each other, the presence of an obstacle or an interfering signal may disturb the communication of these UEs.

On the other hand, the determination of the proximity by ProSe direct discovery is based on whether the UE has received a discovery signal (or a discovery message) wirelessly transmitted from another UE. Therefore, ProSe direct discovery may be useful to the network for determining whether two or more UEs can perform direct communication on a sidelink.

A detailed procedure of ProSe direct discovery is described, for example, in Section 5.3 “ProSe Direct Discovery” of Non-Patent Literature 1. According to this procedure, a monitoring UE monitors received signals using a discovery filter corresponding to a ProSe Application Code used by an announcing UE. The announcing UE is a UE that transmits a discovery signal and meanwhile the monitoring UE is a UE that attempts to receive a discovery signal to detect proximity of an announcing UE related to information of interest. When the monitoring UE detects the discovery signal containing the ProSe Application Code matching the discovery filter, it sends a Match Report to the ProSe Function.

The Match Report sent by the monitoring UE includes the ProSe Application Code matching the discovery filter detected by the monitoring UE and an UE Identity (e.g., IMSI) of the monitoring UE. The ProSe Application Code is associated with a ProSe Application ID. The ProSe Application ID identifies application related information for a ProSe-enabled UE.

The present inventors are investigating to use results of the direct discovery for several new applications. For example, the results of the direct discovery can be used for allocation of radio resources to direct communication and also for selection of a relay UE. The relay UE relays traffic of another UE (e.g., out-of-coverage UEs) between the other UE and the network. If the results of the direct discovery are used for such applications, the above-described Match Report defined in Section 5.3 of Non-Patent Literature 1 may not be able to provide sufficient information to the network.

Accordingly, one of the objects to be attained by embodiments disclosed herein is to provide an apparatus, a method, and a program that provide a discovery report containing contents suitable for use in a network.

### Solution to Problem

In a first aspect, a wireless terminal apparatus includes at least one wireless transceiver and at least one processor. The at least one processor is configured to perform cellular communication and device-to-device (D2D) communication using the at least one wireless transceiver. The at least one processor is further configured to receive a discovery signal wirelessly transmitted from each of at least one other wireless terminal via the D2D communication and to transmit a discovery report to a network via the cellular communication. The discovery report indicates at least one of: (a) an identifier of each of the at least one other wireless terminal; (b) an identifier(s) of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

In a second aspect, a method in a wireless terminal apparatus includes (a) receiving a discovery signal wirelessly transmitted from each of at least one other wireless terminal via device-to-device (D2D) communication, and (b) transmitting a discovery report to a network via cellular communication. The discovery report indicates at least one of: (a) an identifier of each of the at least one other wireless terminal; (b) an identifier(s) of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

In a third aspect, a network node includes a memory and a processor coupled to the memory. The at least one processor is configured to receive a discovery report from a first wireless terminal via cellular communication. The discovery report is related to at least one other wireless terminal a discovery signal wirelessly transmitted from each of which has been received by the first wireless terminal. The discovery report indicates at least one of: (a) an identifier of each of the at least one other wireless terminal; (b) an identifier(s) of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

In a fourth aspect, a method in a network node includes receiving a discovery report from a first wireless terminal via cellular communication. The discovery report is related to at least one other wireless terminal a discovery signal wirelessly transmitted from each of which has been received by the first wireless terminal. the discovery report indicates at least one of: (a) an identifier of each of the at least one other wireless terminal; (b) an identifier(s) of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

In a fifth aspect, a wireless terminal apparatus includes at least one wireless transceiver and at least one processor. The at least one processor is configured to perform cellular communication and device-to-device (D2D) communication using the at least one wireless transceiver. The at least one processor is configured to start an operation of receiving the discovery signal using the at least one wireless transceiver in response to receiving a synchronization signal from any wireless terminal. The discovery signal is used by another wireless terminal to discover the wireless terminal apparatus.

In a sixth aspect, a method in a wireless terminal apparatus includes starting an operation of transmitting a discovery signal in response to receiving a synchronization signal from any wireless terminal. The discovery signal is used by another wireless terminal to discover the wireless terminal apparatus.

In a seventh aspect, a program includes instructions (software codes) that, when loaded onto a computer, causes the computer to perform the method according to the above-described second, fourth, or sixth aspect.

### Advantageous Effects of Invention

According to the above aspects, it is possible to provide an apparatus, a method, and a program that provide a discovery report containing contents suitable for use in a network.

### BRIEF DESCRIPTION OF DRAWINGS

FIG. 1 is a diagram showing a configuration example of a wireless communication network according to a first embodiment;

FIG. 2 is a diagram for describing an example of a direct discovery operation performed by a wireless terminal according to the first embodiment;

FIG. 3 is a diagram for describing an example of a direct discovery operation performed by a wireless terminal according to the first embodiment;

FIG. 4 is a flowchart showing an example of an operation of a wireless terminal (i.e., monitoring terminal) according to the first embodiment;

FIG. 5 is a sequence diagram showing an example of a direct discovery procedure according to a second embodiment;

FIG. 6 is a flowchart showing an example of an operation of a wireless terminal (i.e., monitoring terminal) according to the second embodiment;

FIG. 7 is a flowchart showing an example of an operation of a network node according to the second embodiment:

FIG. 8 is a sequence diagram showing an example of a direct discovery procedure according to a third embodiment;

FIG. 9 is a flowchart showing an example of an operation of a wireless terminal (i.e., announcing terminal) according to the third embodiment;

FIG. 10 is a sequence diagram showing an example of a direct discovery procedure according to a fourth embodiment;

FIG. 11 is a block diagram showing a configuration example of a wireless terminal according to some embodiments;

FIG. 12 is a block diagram showing a configuration example of a base station according to some embodiments; and

FIG. 13 is a block diagram showing a configuration example of a D2D controller according to some embodiments.

### DESCRIPTION OF EMBODIMENTS

Hereinafter, specific embodiments of the present disclosure will be described in detail with reference to the drawings. The same or corresponding elements are denoted by the same signs throughout the drawings, and repeated descriptions will be omitted as necessary.

### First Embodiment

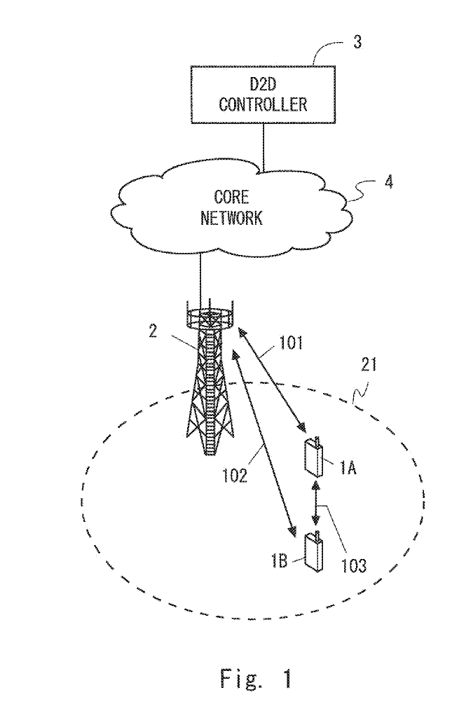

FIG. 1 shows a configuration example of a wireless communication network according to this embodiment. Wireless terminals (mobile stations (MSs)) 1A and 1B each include at least one wireless transceiver and are configured to perform cellular communication (101 or 102) with a base station 2 and to perform D2D communication (e.g., ProSe direct discovery and ProSe direct communication) on an inter-terminal direct interface 103 (e.g., a PC5 interface or sidelink). The base station 2 manages a cell 21 and is able to perform the cellular communication (101 and 102) with each of the plurality of the wireless terminals 1 using a cellular communication technology (e.g., Evolved Universal Terrestrial Radio Access (E-UTRA) technology). Although the example of FIG. 1, indicates an arrangement where the wireless terminals 1A and 1B are located in the same cell 21 for the sake of simplicity of description, this arrangement is merely an example. For example, the wireless terminal 1A may be located in one of two cells that are adjacent to each other and are managed by different base stations 2, and the wireless terminal 1B may be located in the other one of the two cells.

A core network (i.e., Evolved Packet Core (EPC)) 4 includes a plurality of user plane entities (e.g., Serving Gateway (S-GW) and Packet Data Network Gateway (P-GW)) and a plurality of control plane entities (e.g., Mobility Management Entity (MME) and Home Subscriber Server (HSS)). The user plane entities relay user data of the wireless terminals 1A and 1B between an external network and a radio access network including the base station 2. The control plane entities perform various kinds of control for the wireless terminals 1A and 1B including mobility management, session management (bearer management), subscriber information management, and billing management.

In some implementations, in order to use proximity-based services (e.g., 3GPP ProSe), the wireless terminals 1A and 1B are configured to communicate with a D2D controller 3 via the base station 2 and the core network 4. For example, in the case of 3GPP ProSe, the D2D controller 3 corresponds to a ProSe function entity. For example, the wireless terminals 1A and 1B may use network-level discovery (e.g., EPC-level ProSe discovery) provided by the D2D controller 3, may receive from the D2D controller 3 a message indicating permission for the wireless terminals 1A and 1B to activate (enable) D2D communication (e.g., ProSe direct discovery or ProSe direct communication), and may receive from the D2D controller 3 configuration information for D2D communication in the cell 21.

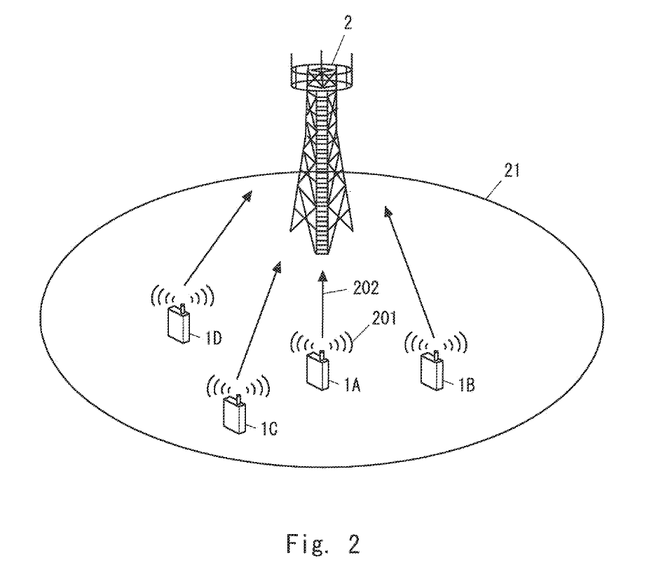

Hereinafter, a direct discovery procedure according to this embodiment will be described with reference to FIGS. 2 to 4. Each wireless terminal 1 according to this embodiment is configured to receive a discovery signal (or a discovery message) wirelessly transmitted from each of at least one other wireless terminal 1 via D2D communication (103). The wireless terminal 1 can discover the at least one other wireless terminal by receiving the discovery signal. Each wireless terminal 1 is further configured to send a discovery report to the network via cellular communication (101 or 102). The discovery report indicates at least one of: (a) an identifier of each of the discovered at least one other wireless terminal 1; (b) an identifier(s) of one or more D2D communication pairs to which each of the discovered at least one other wireless terminal belongs; (c) an identifier of a base station 2 or a cell 21 with which each of the discovered at least one other wireless terminal has been associated; (d) received power of the discovery signal from each of the discovered at least one other wireless terminal 1; and (e) the number of detections of the discovery signal from each of the discovered at least one other wireless terminal 1.

The above-described contents (a) to (e) included in the discovery report according to this embodiment are useful to a network node (e.g., the base station 2 or the D2D controller 3) for making a determination on direct communication. For example, these contents (a) to (e) can be used by the network node to determine another terminal with which the wireless terminal 1 that is a transmission source of the discovery report should perform direct communication. Alternatively, these contents (a) to (e) can be used by the network node to determine a wireless terminal whose traffic is to be relayed through relaying by the wireless terminal 1 that is the transmission source of the discovery report. Alternatively, these contents (a) to (e) can be used by the network node to determine allocation of radio resources to direct communication to be performed by the wireless terminal 1 that is the transmission source of the discovery report.

For example, “(a) an identifier of each of the discovered at least one other wireless terminal 1” can be used by the network node to accurately find out a candidate terminal capable of performing direct communication with the wireless terminal 1 that is the transmission source of the discovery report.

“(b) an identifier(s) of one or more D2D communication pairs to which each of the discovered at least one other wireless terminal belongs” can be used by the network node to find out a D2D communication pair(s) that may be subject to interference from, or may cause interfere to, direct communication performed by the wireless terminal 1 that is the transmission source of the discovery report. Note that the term “D2D communication pair” means a pair of a D2D transmitting terminal and a D2D receiving terminal that perform D2D transmission. The “D2D transmission” includes wirelessly transmitting from one wireless terminal directly to the other wireless terminal in each D2D communication pair without traversing the base station 2.

“(c) an identifier of a base station 2 or a cell 21 with which each of the discovered at least one other wireless terminal has been associated” can be used by the network node to find out which base station 2 each wireless terminal(s) discovered by the wireless terminal 1, which is the transmission source of the discovery report, is associated with (or which cell 21 each discovered wireless terminal belongs to). In other words, the network node can find out whether D2D communication between the cells is necessary.

“(d) received power of the discovery signal from each of the discovered at least one other wireless terminal 1” can be used by the network node to determine the priorities of candidate terminals capable of performing direct communication with the wireless terminal 1 that is the transmission source of the discovery report. Alternatively, the network node may use this information to estimate a throughput of direct communication performed by the wireless terminal 1 that is the transmission source of the discovery report, and may allocate radio resources to the direct communication according to the throughput estimated based on this information.

Likewise, “(e) the number of detections of the discovery signal from each of the discovered at least one other wireless terminal 1” can be used by the network node to determine the priorities of candidate terminals capable of performing direct communication with the wireless terminal 1 that is the transmission source of the discovery report.

FIG. 4 is a flowchart showing an example (process 400) of an operation of sending a discovery report by the wireless terminal 1. In block 401, the wireless terminal 1 receives a discovery signal wirelessly transmitted from each of at least one other wireless terminal 1 via the D2D communication (103). That is, the wireless terminal 1 discovers the at least one other wireless terminal by receiving the discovery signal(s). In block 402, the wireless terminal 1 sends a discovery report regarding the at least one other wireless terminal 1 discovered in block 401 to the network via cellular communication (101 or 102).

The discovery signal transmitted by a neighbor wireless terminal to enable the wireless terminal 1 to send the above discovery report to the base station 2 may include at least one of: (a) an identifier of the neighbor wireless terminal, (b) an identifier(s) of one or more D2D communication pairs to which the neighbor wireless terminal belongs, and (c) an identifier of a base station or a cell with which the neighbor wireless terminal is associated.

As can be understood from the above description, the wireless terminal 1 is configured to send, to the network, the discovery report including at least one of the above-described contents (a) to (e) related to other wireless terminals 1 discovered by the operation of receiving the discovery signal. Therefore, the wireless terminal 1 according to this embodiment can send a discovery report containing contents suitable for use in the network.

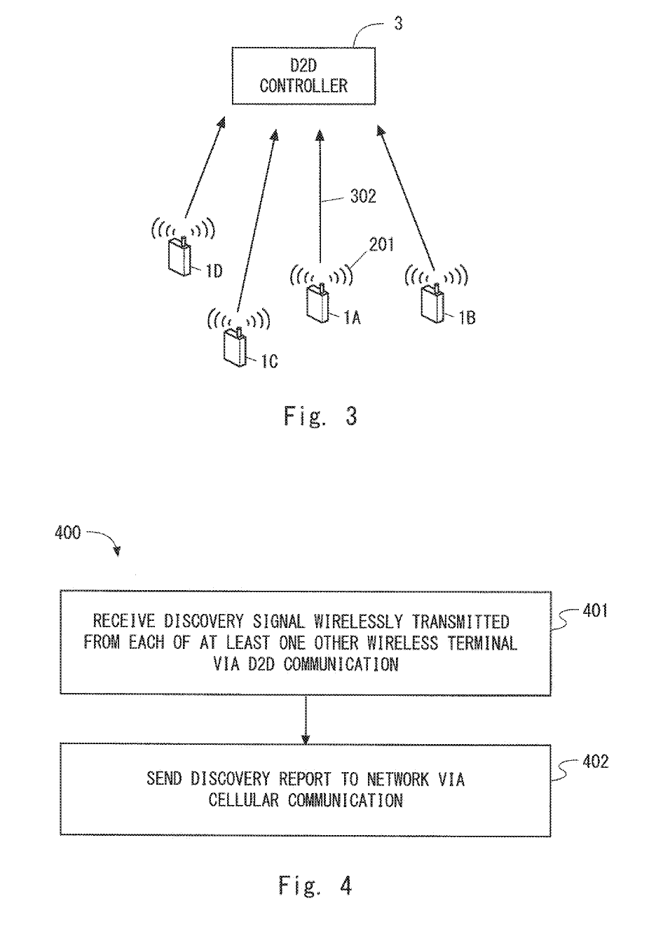

The following provides further details about the discovery report. The network node that is a destination of the discovery report transmitted by the wireless terminal 1 may be appropriately determined according to the application of the discovery report. In some implementations, as shown in FIG. 2, each wireless terminal 1 may transmit a discovery signal 201 to be detected by another wireless terminal(s) 1 and may send a discovery report 202 to the base station 2 based on reception of the discovery signal(s) from at least one other wireless terminal 1. Alternatively, as shown in FIG. 3, each wireless terminal 1 may transmit the discovery signal 201 to be detected by another wireless terminal(s) 1 and may send a discovery report 302 to the D2D controller 3 based on reception of the discovery signal(s) from at least one other wireless terminal 1.

The wireless terminal 1 may send the discovery report periodically or aperiodically. For example, the wireless terminal 1 may send the discovery report to the network in response to receiving the discovery signal from another wireless terminal 1 that has not been previously discovered. Additionally or alternatively, the wireless terminal 1 may send the discovery report to the network when a predetermined period has expired before a new discovery signal is received from another wireless terminal 1 from which the wireless terminal 1 received previously the discovery signal.

Additionally or alternatively, the wireless terminal 1 may send the discovery report to the network in response to receiving a report request from the network via cellular communication (101 or 102). For example, the network node (e.g., the base station 2 or the D2D controller 3) may request the wireless terminal 1 to send the discovery report, for example, in response to receiving from the wireless terminal 1 or another wireless terminal 1 a request for allocating radio resources for D2D communication. Alternatively, in response to detecting proximity between one wireless terminal 1 and another wireless terminal 1 through network-level discovery (e.g., EPC-level ProSe discovery), the network node (e.g., the base station 2 or the D2D controller 3) may request the one wireless terminal 1 to send the discovery report. As already described above, the network-level discovery includes tracking current locations (e.g., GNSS location information) of the one wireless terminal and the other wireless terminal in the network to detect proximity between the one wireless terminal and the other wireless terminal.

The wireless terminal 1 may not record the discovery of other wireless terminal 1 when the wireless terminal 1 has received the discovery signal from the other wireless terminal 1, but the received power of the discovery signal is below a predetermined value. In other words, the wireless terminal 1 may report the discovery of other wireless terminal 1 to the network only when the received power of the discovery signal received from the other wireless terminal 1 exceeds a predetermined threshold.

The following provides specific examples of a condition for starting an operation of transmitting the discovery signal by the wireless terminal 1. In one example, the wireless terminal 1 may start the operation of transmitting the discovery signal in response to receiving a request from a network node (e.g., the base station 2 or the D2D controller 3). For example, the network node (e.g., the base station 2 or the D2D controller 3) may request, to transmit the discovery signal, a wireless terminal 1 that is transmitting a synchronization signal (e.g., Sidelink Synchronization Signal) on the inter-terminal direct interface (e.g., PC5 interface or sidelink) 103.

In some implementations, when the wireless terminal 1 is in the vicinity of a coverage boundary of the base station 2 (i.e., a cell edge of the cell 21), the wireless terminal 1 may transmit autonomously, or in accordance with an instruction of the network (e.g., the base station 2 or the D2D controller 3), the synchronization signal (e.g., Sidelink Synchronization Signal) to be detected by another wireless terminal(s) 1. In some implementations, the wireless terminal 1 may autonomously transmit the synchronization signal when reception quality (e.g., Reference Signal Received Power (RSRP) or Reference Signal Received Quality (RSRQ)) of a wireless signal transmitted from the base station 2 is below a threshold. In some implementations, the network (e.g., the base station 2 or the D2D controller 3) may identify the wireless terminal(s) 1 located near the cell edge and instruct these wireless terminal(s) to transmit the synchronization signal. In some implementations, when the network (e.g., the base station 2 or the D2D controller 3) receives, from any wireless terminal 1, a report (e.g., RRC measurement report) indicating that it is about to be out-of-coverage, the network may instruct another wireless terminal(s) 1, which is different from the wireless terminal that made the report and is near the cell edge of the cell 21, to transmit the synchronization signal.

Alternatively, in response to detecting proximity between one wireless terminal 1 and another wireless terminal 1 by network-level discovery (e.g., EPC-level ProSe discovery), the network node (e.g., the base station 2 or the D2D controller 3) may request the other wireless terminal 1 to transmit the discovery signal.

Additionally or alternatively, when one wireless terminal or another wireless terminal 1 is present in a predetermined area, the network node (e.g., the base station 2 or the D2D controller 3) may request the other wireless terminal to transmit the discovery signal. The predetermined area may be, for example, an area in proximity to the coverage boundary (the cell edge) of the cell 21.

In another example, the wireless terminal 1 may autonomously start the operation of transmitting the discovery signal. For example, the wireless terminal 1 may transmit the discovery signal according to a predetermined schedule. For example, the schedule may define a transmission start time and an end time (or transmission duration). Additionally or alternatively, the wireless terminal 1 may autonomously start transmitting the discovery signal when reception quality (e.g., RSRP or RSRQ) of a wireless signal transmitted from the base station 2 is lower than a threshold. Additionally or alternatively, the wireless terminal 1 may start transmitting the discovery signal in response to receiving the above-described synchronization signal (e.g., Sidelink Synchronization Signal) from any other wireless terminal 1.

The following provides a specific example of a condition for starting a discovery operation (i.e., an operation of receiving the discovery signal) by the wireless terminal 1. In one example, the wireless terminal 1 may start the operation of receiving the discovery signal in accordance with a request from the network (e.g., the base station 2 or the D2D controller 3). In another example, the wireless terminal 1 may autonomously start the operation of receiving the discovery signal. For example, the wireless terminal 1 may start receiving the discovery signal in response to receiving the above-described synchronization signal (e.g., Sidelink Synchronization Signal) from any other wireless terminal 1.

### Second Embodiment

This embodiment provides a specific example of the direct discovery procedure described in the first embodiment. A configuration example of a wireless communication network according to this embodiment is the same as that shown in FIGS. 1 to 3.

In this embodiment, the wireless terminal 1 is configured, in response to receiving a report request from the network (e.g., the base station 2 or the D2D controller 3), to send to the network a discovery report including at least one of the above-described contents (a) to (e) related to another wireless terminal 1 that has been discovered by the operation of receiving a discovery signal. Thus, the network (e.g., the base station 2 or the D2D controller 3) can promptly obtain the discovery report when the network needs the discovery report.

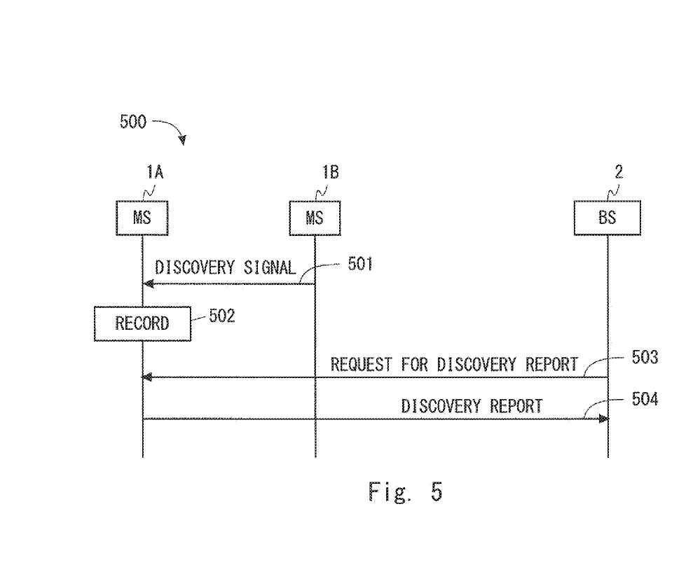

FIG. 5 is a sequence diagram showing an example (process 500) of the direct discovery procedure according to this embodiment. In block 501, a wireless terminal (MS) 1B transmits a discovery signal. In block 502, a wireless terminal (MS) 1A receives the discovery signal from a wireless terminal 1B and records information on the reception (e.g., an identifier of the wireless terminal 1B, an identifier of a base station 2 or a cell 21 with which the wireless terminal 1B is associated, the received power of the discovery signal, and the cumulative received number of the discovery signals).

In block 503, a network node (in this case, a base station 21) sends to the wireless terminal 1A a request for a discovery report. In block 504, the wireless terminal 1A sends the discovery report to the network node (in this case, the base station 21) in response to receiving the request. The discovery report may include contents related to all the discovered wireless terminals 1 that has already been discovered at the time of the reception of the request (503), or may include contents related to a particular one or more wireless terminals 1 specified in the request (503).

In the example of FIG. 5, the transmission of the request (503) for the discovery report and the reception of the discovery report (504) may be performed by a network node (e.g., the D2D controller 3) other than the base station 2.

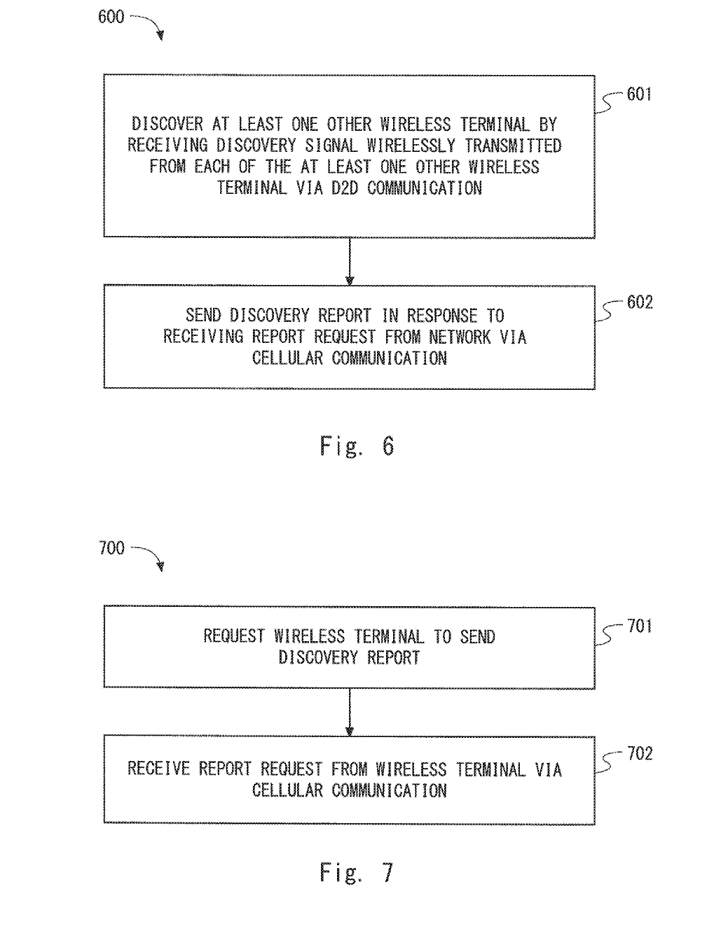

FIG. 6 is a flowchart showing an example (process 600) of an operation of the wireless terminal 1 (monitoring terminal) for performing a discovery reporting. In block 601, the wireless terminal 1 receives a discovery signal wirelessly transmitted from each of at least one other wireless terminal 1 via D2D communication (103), thereby discovering the at least one other wireless terminal 1. In block 602, the wireless terminal 1 sends a discovery report to the network in response to receiving a report request from the network via cellular communication (101 or 102).

FIG. 7 is a flowchart showing an example of an operation (process 700) of the network node (e.g., the base station 2 or the D2D controller 3) for receiving the discovery report. In block 701, the network node requests a wireless terminal 1 to send the discovery report. In block 702, the network node receives a report request from the wireless terminal 1 via cellular communication (101 or 102).

### Third Embodiment

This embodiment provides a specific example of the direct discovery procedure described in the first embodiment. A configuration example of a wireless communication network according to this embodiment is the same as that shown in FIGS. 1 to 3.

In this embodiment, a network node (e.g., base station 2 or D2D controller 3) is configured to send to a wireless terminal 1 an instruction (or request) for transmitting a discovery signal (or discovery message). Meanwhile, the wireless terminal 1 is configured to start transmitting the discovery signal (or discovery message) in response to receiving the instruction (or request) from the network (e.g., the base station 2 or the D2D controller 3). In this way, the network (e.g., the base station 2 or the D2D controller 3) can specify the terminal to transmit the discovery signal. Further, as the network controls the transmission timing of the discovery signal by the wireless terminal 1, it is possible to contribute to reducing the interference in the D2D communication.

The network node may request the wireless terminal 1 to transmit the discovery signal when one of the conditions described in the first embodiment is satisfied. Specifically, in one example, the network node may request, to transmit the discovery signal, the wireless terminal 1 that is transmitting a synchronization signal (e.g., Sidelink Synchronization Signal) on the inter-terminal direct interface (e.g., the PC5 interface or the sidelink) 103. In another example, in response to detecting proximity between one wireless terminal 1 and another wireless terminal 1 through network-level discovery (e.g., EPC-level ProSe discovery), the network node may request the other wireless terminal 1 to transmit the discovery signal. In yet another example, when one wireless terminal or another wireless terminal 1 is present in a predetermined area, the network node may request the other wireless terminal to transmit the discovery signal. The predetermined area may be, for example, an area in the vicinity of a coverage boundary (i.e., cell edge) of the cell 21.

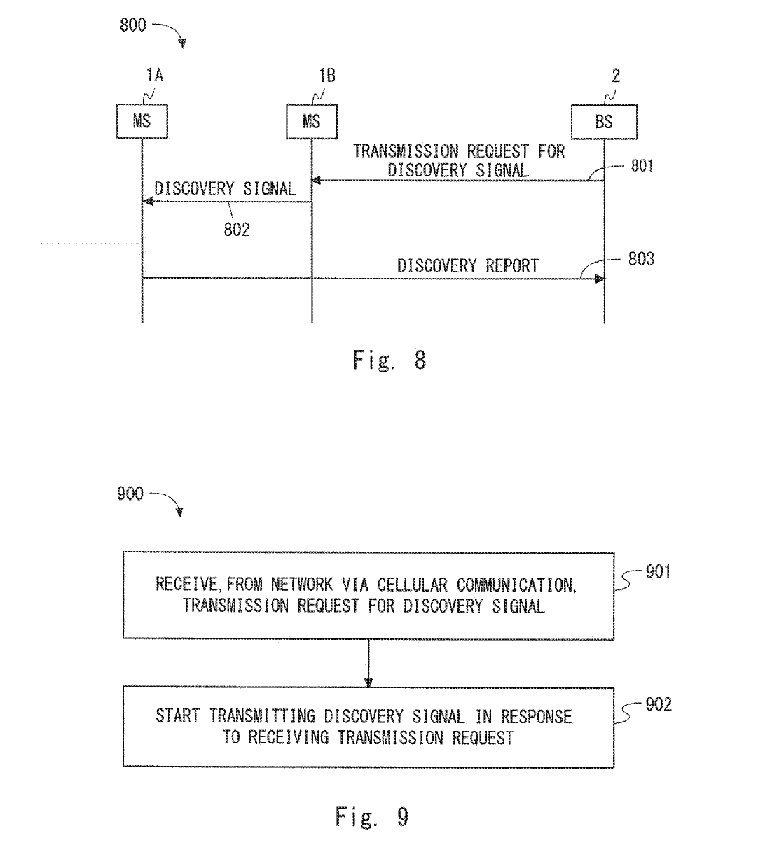

FIG. 8 is a sequence diagram showing an example (process 800) of the direct discovery procedure according to this embodiment. In block 801, a network node (in this case, the base station 21) sends to a wireless terminal (MS) 1B a request for transmission of the discovery signal. In block 802, the wireless terminal 1B starts transmitting the discovery signal in response to receiving the request (801). In block 803, a wireless terminal 1A receives the discovery signal from the wireless terminal 1B and sends the discovery report to the network node (in this case, the base station 21). The transmission of the request (801) for transmitting the discovery signal and the reception of the discovery report (803) may be performed by a network node (e.g., the D2D controller 3) other than the base station 2.

FIG. 9 is a flowchart showing an example (process 900) of the operation of the wireless terminal 1 (announcing terminal) for transmitting the discovery signal. In block 901, the wireless terminal 1 receives a request for transmission of the discovery signal from the network via cellular communication. In block 902, the wireless terminal 1 starts transmitting the discovery signal in response to receiving the request.

### Fourth Embodiment

This embodiment provides a specific example of the direct discovery procedure described in the first embodiment. A configuration example of a wireless communication network according to this embodiment is the same as that shown in FIGS. 1 to 3.

In this embodiment, the wireless terminal 1 is configured to autonomously start transmitting a discovery signal (or discovery message). Accordingly, the wireless terminal 1 can start transmitting the discovery signal without requiring communication with the network, and thus it can transmit the discovery signal even in a situation where communication with the network is not available. Further, by determining the condition for the wireless terminal 1 to autonomously transmit the discovery signal, it is possible to contribute to reducing interference in the D2D communication.

The wireless terminal 1 may start transmitting the discovery signal when one of the conditions described in the first embodiment is satisfied. Specifically, in one example, the wireless terminal 1 may transmit the discovery signal according to a predetermined schedule. In another example, the wireless terminal 1 may autonomously start transmitting the discovery signal when reception quality (e.g., RSRP or RSRQ) of a wireless signal transmitted from the base station 2 is lower than a threshold. In yet another example, the wireless terminal 1 may start transmitting the discovery signal in response to receiving the above-described synchronization signal (e.g., Sidelink Synchronization Signal) from any other wireless terminal 1.

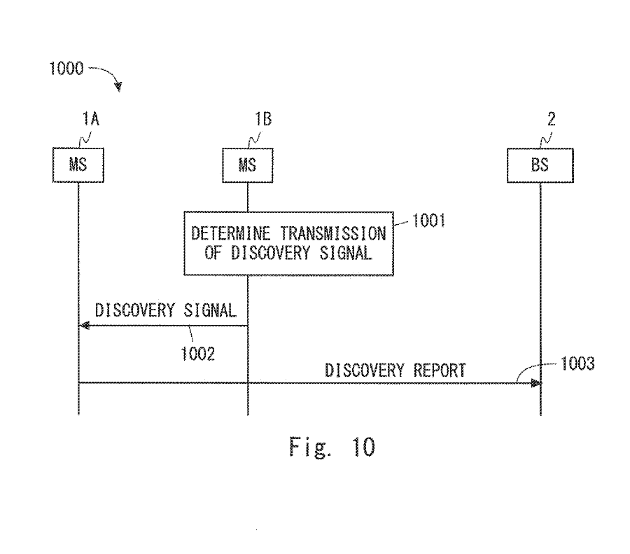

FIG. 10 is a sequence diagram showing an example (process 1000) of the direct discovery procedure according to this embodiment. In block 1001, a wireless terminal 1B autonomously determines to transmit the discovery signal. In block 1002, the wireless terminal 1B transmits the discovery signal. In block 1003, a wireless terminal 1A receives the discovery signal from the wireless terminal 1B and sends a discovery report to a network node (in this case, the base station 21). The reception of the discovery report (1003) may be performed by a network node (e.g., the D2D controller 3) other than the base station 2.

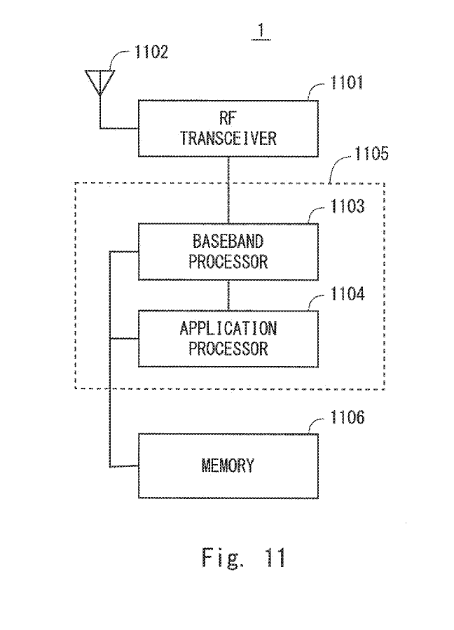

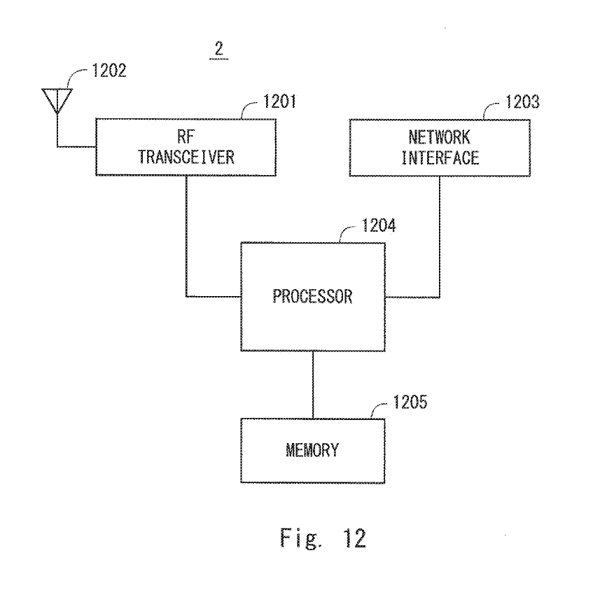

Lastly, a configuration example of the wireless terminal 1, the base station 2, and the D2D controller 3 according to the above-described embodiments will be described. FIG. 11 is a block diagram showing a configuration example of the wireless terminal 1. A Radio Frequency (RF) transceiver 1101 performs analog RF signal processing to communicate with the base station 2. The analog RF signal processing performed by the RF transceiver 1101 includes frequency up-conversion, frequency down-conversion, and amplification. The RF transceiver 1101 is coupled to an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. Moreover, the RF transceiver 1101 generates a baseband reception signal based on a reception RF signal received by the antenna 1102, and supplies the baseband reception signal to the baseband processor 1103.

The baseband processor 1103 performs digital baseband signal processing (i.e., data-plane processing) and control-plane processing for wireless communication. The digital baseband signal processing includes (a) data compression/decompression, (b) data segmentation/concatenation, (c) generation/decomposition of a transmission format (i.e., transmission frame), (d) channel coding/decoding, (e) modulation (i.e., symbol mapping)/demodulation, (f) generation of OFDM symbol data (i.e., baseband OFDM signal) by Inverse Fast Fourier Transform (IFFT), and the like. On the other hand, the control plane processing includes communication management in the layer 1 (e.g., transmission power control), layer 2 (e.g., radio resource management and hybrid automatic repeat request

(HARQ) processing), and layer 3 (e.g., signaling regarding attach, mobility, and call management).

For example, in the case of LTE and LTE-Advanced, the digital baseband signal processing performed by the baseband processor 1103 may include signal processing of the Packet Data Convergence Protocol (PDCP) layer, Radio Link Control (RLC) layer, MAC layer, and PHY layer. Further, the control plane processing performed by the baseband processor 1103 may include processing of the Non-Access Stratum (NAS) protocol, RRC protocol, and MAC CE.

The baseband processor 1103 may include a modem processor (e.g., Digital Signal Processor (DSP)) that performs the digital baseband signal processing and a protocol stack processor (e.g., Central Processing Unit (CPU) or Micro Processing Unit (MPU)) that performs the control-plane processing. In this case, the protocol stack processor that performs the control-plane processing may be integrated with an application processor 1104 described in the following.

The application processor 1104 is also referred to as a CPU, an MPU, a microprocessor, or a processor core. The application processor 1104 may include a plurality of processors (or processor cores). The application processor 1104 loads a system software program (Operating System (OS)) and various application programs (e.g., voice call application, WEB browser, mailer, camera operation application, and music player application) from a memory 1106 or from another memory (not shown) and executes these programs, thereby providing various functions of the radio terminal 1.

In some implementations, as indicated by the dashed line (1105) in FIG. 11, the baseband processor 1103 and the application processor 1104 may be integrated on a single chip. In other words, the baseband processor 1103 and the application processor 1104 may be implemented in a single System on Chip (SoC) device 1105. A SoC device may be referred to as a system Large Scale Integration (LSI) or a chipset.

The memory 1106 is a volatile memory or a non-volatile memory or a combination thereof. The memory 1106 may include a plurality of physically independent memory devices. The volatile memory is, for example, Static Random Access Memory (SRAM), Dynamic RAM (DRAM) or a combination thereof. The non-volatile memory may be a Mask Read Only Memory (MROM), an Electrically Erasable Programmable ROM (EEPROM), a flash memory, a hard disk drive, or any combination thereof. The memory 1106 may include an internal memory device integrated within the baseband processor 1103, the application processor 1104, or the SoC 1105. The memory 1106 may include an external memory device accessible from the baseband processor 1103, the application processor 1104, and the SoC 1105. The memory 1106 may further include a memory in a Universal Integrated Circuit Card (UICC).

The memory 1106 may store a software module(s) (computer program(s)) including instructions and data to perform processing by the radio terminal 1 described in the above described plurality of embodiments. In some implementations, the baseband processor 1103 or the application processor 1104 may be configured to load the software module(s) from the memory 1106 and execute the loaded software module(s), thereby performing the processing of the radio terminal 1 described in the above described embodiments.

FIG. 12 is a block diagram showing a configuration example of the base station 2 according to the above embodiments. Referring to FIG. 12, the base station 2 includes an RF transceiver 1201, a network interface 1203, a processor 1204, and a memory 1205. The RF transceiver 1201 performs analog RF signal processing to communicate with the wireless terminal 1. The RF transceiver 1201 may include a plurality of transceivers. The RF transceiver 1201 is coupled to an antenna 1202 and a processor 1204. The RF transceiver 1201 receives modulated symbol data (or OFDM symbol data) from the processor 1204, generates a transmission RF signal, and supplies the transmission RF signal to the antenna 1202. Moreover, the RF transceiver 1201 generates a baseband reception signal based on a reception RF signal received by the antenna 1202, and supplies the baseband reception signal to the processor 1204.

The network interface 1203 is used to communicate with network nodes (e.g., Mobility Management Entities (MME) and Serving Gateways (S-GWs)). The network interface 1203 may include, for example, a network interface card (NIC) conforming to IEEE 802.3 series.

The baseband processor 1204 performs digital baseband signal processing (i.e., data-plane processing) and control-plane processing for wireless communication. For example, in the case of LTE and LTE-Advanced, the digital baseband signal processing performed by the baseband processor 1204 may include signal processing of the PDCP layer, RLC layer, MAC layer, and PHY layer. Further, the control-plane processing performed by the baseband processor 1204 may include processing of the 51 protocol, RRC protocol, and MAC CE.

The processor 1204 may include a plurality of processors. For example, the processor 1204 may include a modem processor (e.g., DSP) that performs the digital baseband signal processing and a protocol stack processor (e.g., CPU or MPU) that performs the control plane processing.

The memory 1205 is composed of a combination of a volatile memory and a non-volatile memory. The volatile memory is, for example, SRAM, DRAM, or a combination thereof. The non-volatile memory may be a MROM, a PROM, a flash memory, a hard disk drive, or any combination thereof. The memory 1205 may include a storage disposed separately from the processor 1204. In this case, the processor 1204 may access the memory 1205 via the network interface 1203 or an I/O interface (not shown).

The memory 1205 may store a software module(s) (computer program(s)) including instructions and data to perform processing by the base station 2 described in the above embodiments. In some implementations, the processor 1204 may be configured to load the software module(s) from the memory 1205 and execute the loaded software module(s), thereby performing the processing of the base station 2 described in the above described embodiments.

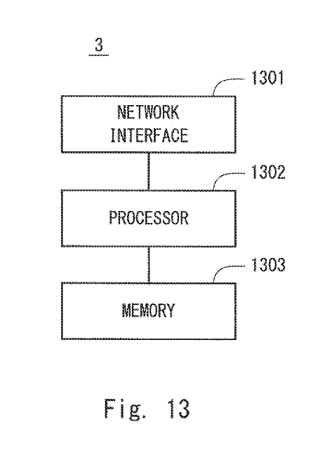

FIG. 13 is a block diagram showing a configuration example of the D2D controller 3 according to the above embodiments. Referring to FIG. 13, the D2D controller 3 includes a network interface 1301, a processor 1302, and a memory 1303. The network interface 1301 is used to communicate with the wireless terminal 1.

The network interface 1301 may include, for example, a network interface card (NIC) conforming to the IEEE 802.3 series.

The processor 1302 loads software (computer programs) from the memory 1303 and executes the loaded software, thereby performing the processing of the D2D controller 3 described with reference to the sequence diagrams and the flowcharts in the above embodiments. The processor 1302 may be, for example, a microprocessor, MPU, or CPU. The processor 1302 may include a plurality of processors.

The memory 1303 is composed of a combination of a volatile memory and a non-volatile memory. The memory 1303 may include a storage disposed separately from the processor 1302. In this case, the processor 1302 may access the memory 1303 via an I/O interface (not shown).

In the example of FIG. 13, the memory 1303 is used to store software modules including a control module for the D2D communication. The processor 1302 loads these software modules from the memory 1303 and executes the loaded software modules, thereby performing the processing of the D2D controller 3 described in the above embodiments.

As described with reference to FIGS. 11 to 13, each of the processors included in the wireless terminal 1, the base station 2, and the D2D controller 3 according to the above-described embodiments executes one or more programs including instructions for causing a computer to perform the algorithm described with reference to the drawings. These programs can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), Compact Disc Read Only Memory (CD-ROM), CD-R, CD-R/W, semiconductor memories (such as Mask ROM, Programmable ROM (PROM), Erasable PROM (EPROM), flash ROM, Random Access Memory(RAM)). These programs can be provided to a computer using any type of transitory computer readable media. Examples of the transitory computer readable media include an electrical signal, an optical signal, and an electromagnetic wave. Transitory computer readable media can provide a program to a computer via a wired communication line (e.g. electric wires, and optical fibers) or a wireless communication line.

### Other Embodiments

Each of the above embodiments may be used individually, or two or more of the embodiments may be appropriately combined with one another.

Further, the above-described embodiments are merely examples of applications of the technical ideas obtained by the inventors. The technical ideas are not limited to the above-described embodiments, and various changes and modifications may be made thereto.

The present application is based upon and claims the benefit of priority from Japanese Patent Application No. 2015-112699, filed on Jun. 2, 2015, the entire contents of which are hereby incorporated by reference.

### REFERENCE SIGNS LIST

1 WIRELESS TERMINAL

2 BASE STATION

3 DEVICE-TO-DEVICE (D2D) CONTROLLER

1101 RADIO FREQUENCY (RF) TRANSCEIVER

1103 BASEBAND PROCESSOR

1104 APPLICATION PROCESSOR

1106 MEMORY

1201 RF TRANSCEIVER

1204 PROCESSOR

1205 MEMORY

1302 PROCESSOR

1303 MEMORY

1. A wireless terminal apparatus comprising:
at least one wireless transceiver; and
at least one processor configured to perform cellular communication and device-to-device (D2D) communication using the at least one wireless transceiver, wherein
the at least one processor is configured to receive a discovery signal wirelessly transmitted from each of at least one other wireless terminal via the D2D communication and to send a discovery report to a network via the cellular communication, and
the discovery report indicates at least one of: (a) an identifier of each of the at least one other wireless terminal; (b) an identifier of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

2. The wireless terminal apparatus according to claim 1, wherein the at least one processor is configured to send the discovery report to the network in response receiving a report request from the network via the cellular communication.

3. The wireless terminal apparatus according to claim 2, wherein the report request is sent from the network in response to receiving, by the network, information for the D2D communication from the wireless terminal apparatus or any one of the at least one other wireless terminal.

4. The wireless terminal apparatus according to claim 2, wherein
the report request is sent from the network in response to detecting, by the network, proximity between the wireless terminal apparatus and the at least one other wireless terminal through network-level discovery, and
the network-level discovery comprises tracking, in the network, current locations of the wireless terminal apparatus and the at least one other wireless terminal to detect the proximity between the wireless terminal apparatus and the at least one other wireless terminal.

5. The wireless terminal apparatus according to claim 1, wherein the at least one processor is configured to send the discovery report to the network in response to receiving the discovery signal from a wireless terminal that has not been previously discovered.

6. The wireless terminal apparatus according to claim 1, wherein the at least one processor is configured to send the discovery report to the network when a predetermined period has expired before the discovery signal is newly received from a wireless terminal from which the at least one processor previously received the discovery signal.

7. The wireless terminal apparatus according to claim 1, wherein the at least one processor is configured to start an operation of receiving the discovery signal in response to receiving a synchronization signal from any wireless terminal.

8. The wireless terminal apparatus according to claim 1, wherein the at least one processor is configured not to record the discovery of a certain wireless terminal when the at least one processor has received the discovery signal from the certain wireless terminal, but received power of the discovery signal is below a predetermined value.

9. The wireless terminal apparatus according to claim 1, wherein the discovery report is used in the network to determine a wireless terminal whose traffic is to be relayed through relaying by the wireless terminal apparatus.

10. The wireless terminal apparatus according to claim 1, wherein the discovery signal is transmitted from the at least one other wireless terminal in response to reception by the at least one other wireless terminal of a synchronization signal from any wireless terminal.

11. The wireless terminal apparatus according to claim 7, wherein the synchronization signal is transmitted by a wireless terminal located in proximity to a coverage boundary of the network.

12. The wireless terminal apparatus according to claim 1, wherein the at least one processor is configured to send the discovery report to a base station or a D2D controller in the network.

13. A method in a wireless terminal apparatus comprising:
receiving a discovery signal wirelessly transmitted from each of at least one other wireless terminal via device-to-device (D2D) communication; and
sending a discovery report to a network via cellular communication, wherein
the discovery report indicates at least one of: (a) an identifier of each of the at least one other wireless terminal; (b) an identifier of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

14-21. (canceled)

22. A network node comprising:
a memory; and
a processor coupled to the memory, wherein
the at least one processor is configured to receive a discovery report from a first wireless terminal via cellular communication,
the discovery report is related to at least one other wireless terminal a discovery signal wirelessly transmitted from each of which has been received by the first wireless terminal, and
the discovery report indicates at least one of: (a) an identifier of each of the at least one other wireless terminal; (b) an identifier of one or more D2D communication pairs to which each of the at least one other wireless terminal belongs; (c) an identifier of a base station or a cell with which each of the at least one other wireless terminal is associated; (d) received power of the discovery signal from each of the at least one other wireless terminal; and (e) the number of detections of the discovery signal from each of the at least one other wireless terminal.

23. The network node according to claim 22, wherein the at least one processor is configured to use the discovery report to determine a wireless terminal whose traffic is to be relayed through relaying by the first wireless terminal.

24. The network node according to claim 22, wherein the at least one processor is configured to request the first wireless terminal to transmit the discovery report.

25. The network node according to claim 24, wherein the at least one processor is configured to request the transmission of the discovery report in response to receiving information for the D2D communication from the first wireless terminal or any one of the at least one other wireless terminal.

26. The network node according to claim 22, wherein the at least one processor is configured to request the at least one other wireless terminal to transmit the discovery signal.

27. The network node according to claim 26, wherein the at least one processor is configured to request a wireless terminal that is transmitting the synchronization signal to transmit the discovery signal.

28. The network node according to claim 26, wherein
the at least one processor is configured to request each of the at least one other wireless terminal to transmit the discovery signal in response to detecting proximity between the first wireless terminal and the at least one other wireless terminal through network-level discovery, and
the network-level discovery comprises tracking, in the network, current locations of the first wireless terminal and the at least one other wireless terminal to detect the proximity between the first wireless terminal and the at least one other wireless terminal.

29-45. (canceled)
